(19) United States
(12) Patent Application Publication
(10) Pub. No.: US 2011/0152731 A1
(43) Pub. Date: Jun. 23, 2011

(54) PASSIVE EXERCISE APPARATUS

(76) Inventors: Kazuhiro Ochi, Osaka-shi (JP); Youichi Shinomiya, Ibaraki-shi (JP); Takao Gotou, Hirakata-shi (JP); Takahisa Ozawa, Katano-shi (JP)

(21) Appl. No.: 12/808,640

(22) PCT Filed: Dec. 25, 2008
(86) PCT No.: PCT/JP2008/073558

§ 371 Date: Jun. 16, 2010

(30) Foreign Application Priority Data
Dec. 28, 2007 (JP) 2007-341326

(51) Int. Cl. A61H 1/00

(52) U.S. Cl. 601/5

(57) ABSTRACT

This invention has an object to provide a passive exercise apparatus which is driven to help user to stretch and contract various muscles of his/her feet by a driving force generated at a driving unit while not lowering positive effects in his/her exercise. This passive exercise apparatus in the present invention comprises a left foot support 2a, a right foot support 2b, a driving unit 3, and a motion pattern modifying means 6. The left foot support and the right foot support are provided to support user's left foot and right foot respectively. The driving unit is configured to give a reciprocatory motion along a predetermined path to each of the left foot support and the right foot support according to a predetermined motion pattern defined by frequency, phase, and amplitude of the reciprocatory motion. The motion pattern modifying means is configured to modify at least one of the frequency, the phase, and the amplitude. The motion pattern modifying means is configured also to modify the motion pattern in accordance with inputs at a motion pattern setting unit 7.

### TECHNICAL FIELD

This invention relates to a passive exercise apparatus which is driven to apply an external force to user's feet for stretching and contracting muscles of user's feet.

### BACKGROUND ART

Passive exercise apparatus has been proposed as an exercise apparatus which comprises foot supports (footplates) supporting user's left and right feet and a driving device, as disclosed in Japanese unexamined patent application publication No. 2004-267724. The driving device includes an electric motor or the like, giving a driving force for a reciprocatory motion to each foot support.

This exercise apparatus in Japanese unexamined patent application publication No. 2004-267724 comprises a swinging unit and a driving unit including an electric motor for driving the swinging unit. The swinging unit is designed to swing each foot support upward and downward alternately around a shaft which is provided to the rear side of each foot support. This exercise apparatus helps user to stretch his/her feet upward and downward alternately with the aid of the electric motor, for stretching and contracting his/her both ankles alternately.

This passive exercise apparatus is driven to give motions to the foot supports by the driving force generated at the driving unit. With the help of motions of each foot support, this passive exercise apparatus allows user to exercise without need for his/her voluntary motions, even though the user simply places his/her feet on foot supports. Namely, this passive exercise apparatus allows the user to experience a reduced load compared to his/her voluntary exercises, thereby enabling to facilitate his/her continuous exercise.

The conventional passive exercise apparatus is driven to reciprocate the foot supports by the driving unit as mentioned above. However, this conventional passive exercise apparatus generally brings little change in motions of user's feet, hence causing his/her exercise to be monotonous compared to his/her voluntary exercises not relying on driving force generated by the driving unit. This conventional passive exercise apparatus brings little change in user's exercise in his/her everyday use, possibly causing his/her excise effects to gradually decrease. Besides, this conventional passive exercise apparatus allows user to stretch and contract particular portions in muscles of user's feet, but not stretching and contracting various muscles of user's feet.

### DISCLOSURE OF THE INVENTION

This invention is intended to overcome the above problem, and has a main object to provide a passive exercise apparatus which is driven to help user to stretch and contract his/her feet by a driving force generated at a driving unit. The passive exercise apparatus enables user to stretch and contract the whole muscles of his/her feet, while not lowering positive effects in his/her exercise.

The passive exercise apparatus in the present invention comprises a left foot support, a right foot support, a driving unit, and a motion pattern modifying means. The left foot support and the right foot support are provided to support user's left foot and right foot respectively. The driving unit is configured to give a reciprocatory motion along a predetermined path to each of the left foot support and the right foot support according to a predetermined motion pattern defined by frequency, phase, and amplitude of the reciprocatory motion. The motion pattern modifying means is configured to modify at least one of the frequency, the phase, and the amplitude with time.

In this configuration, the motion pattern modifying means is configured to modify at least one of the frequency, the phase, and the amplitude of the reciprocatory motion of each foot support, for the purpose of varying motions of user's feet rather than maintaining a monotonous motion. This passive exercise apparatus hardly gives the monotonous motions in user's everyday use thereof, suppressing gradual reduction of positive effects in his/her exercise. This passive exercise apparatus enables user to stretch and contract various portions in muscles of his/her feet by modifying at least one of the frequency, the phase, and the amplitude with time, thereby being suitable to users who wish to stretch and contract various muscles of his/her feet.

In the passive exercise apparatus in this invention, the motion pattern modifying means is preferably configured to define the motion pattern which is obtained by superposition of a plurality of sinusoidal waveforms of different frequencies. In this configuration, the passive exercise passive apparatus enables to give a complicated reciprocatory motion according to superposition of a plurality of sinusoidal waveforms of different frequencies, rather than giving a monotonous reciprocatory motion according to a single sinusoidal waveform. This passive exercise apparatus hardly gives monotonous motion to user's feet, hence enabling to enhance positive effects in user's exercise.

### BRIEF DESCRIPTION OF THE DRAWINGS

FIG. 1 shows components of a passive exercise apparatus in first embodiment of the present invention.

FIG. 2 shows a perspective view of the above passive exercise apparatus.

FIG. 3 shows a plane view of the above passive exercise apparatus.

FIG. 4 shows an explored perspective view of the above passive exercise apparatus.

FIG. 5 shows a sectional view in rear side of essential parts of the above passive exercise apparatus.

FIG. 6 shows (a) a schematic plan view of the above passive exercise apparatus, (b) a variation in a displacement amount of reciprocatory motion of a foot support in the above passive exercise apparatus, and (c) a variation in output ratio of load sensors.

FIG. 7 shows (a) a variation in a displacement amount of the foot support in connection with its reciprocatory motion defined by a superposition of a plurality of waveforms in the above passive exercise apparatus and (b) each of the waveforms for being superimposed to form a superimposed waveform (a).

FIG. 8 shows (a) a sectional side view and (b) a schematic plan view of essential parts of a passive exercise apparatus in second embodiment of the present invention.

FIG. 9 shows a schematic plan view of essential parts of a passive exercise apparatus in third embodiment of the present invention.

### BEST MODE FOR CARRYING OUT THE INVENTION

### First Embodiment

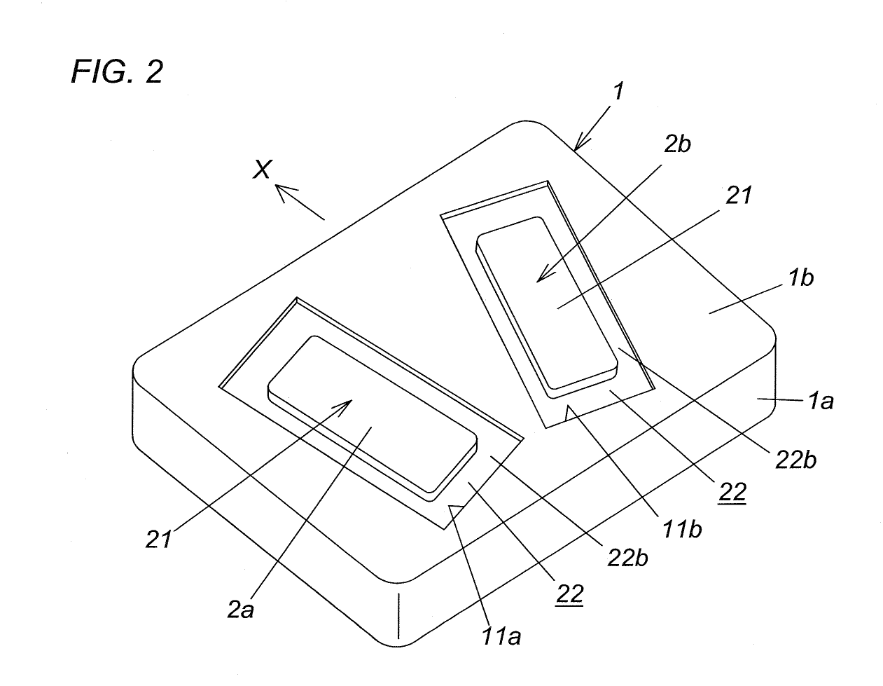

The passive exercise apparatus in this embodiment comprises a housing 1 shaped like shallow box, a left foot support 2a and a right foot support 2b, as shown in FIG. 2. The left foot support 2a and the right foot support 2b are disposed to one surface of the housing 1 for supporting user's left foot and right feet respectively. In this embodiment, a user of the passive exercise apparatus places the housing 1 on a floor, and then places his/her left foot and right foot respectively on the left foot support 2a and the right foot support 2b to keep his/her standing. This passive exercise apparatus may be configured such that the user is allowed to enjoy his/her exercise while sitting. Besides, the housing 1 may be embedded into the floor. Hereafter, upward and downward directions in this embodiment are respectively defined as directions towards top and bottom surfaces of the housing 1 which is placed on the floor. The left foot support 2a and the right foot support 2b is aligned along left/right direction. Forward direction is defined as a direction indicated by X in FIG. 2. Namely, the forward/backward and left/right directions in this embodiment are coincident with directions which are determined with reference to user's normal standing stance on this passive exercise apparatus.

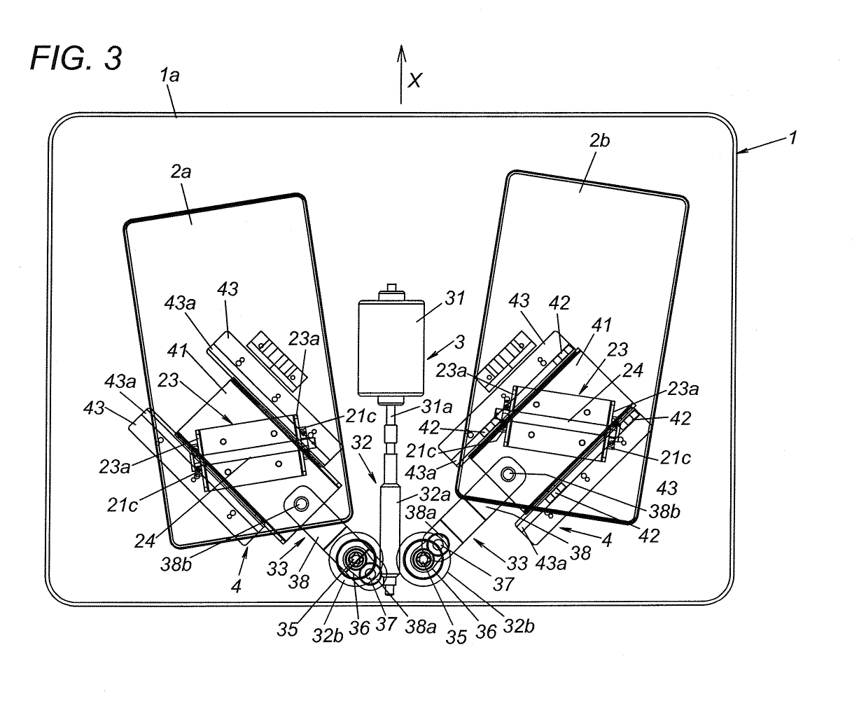

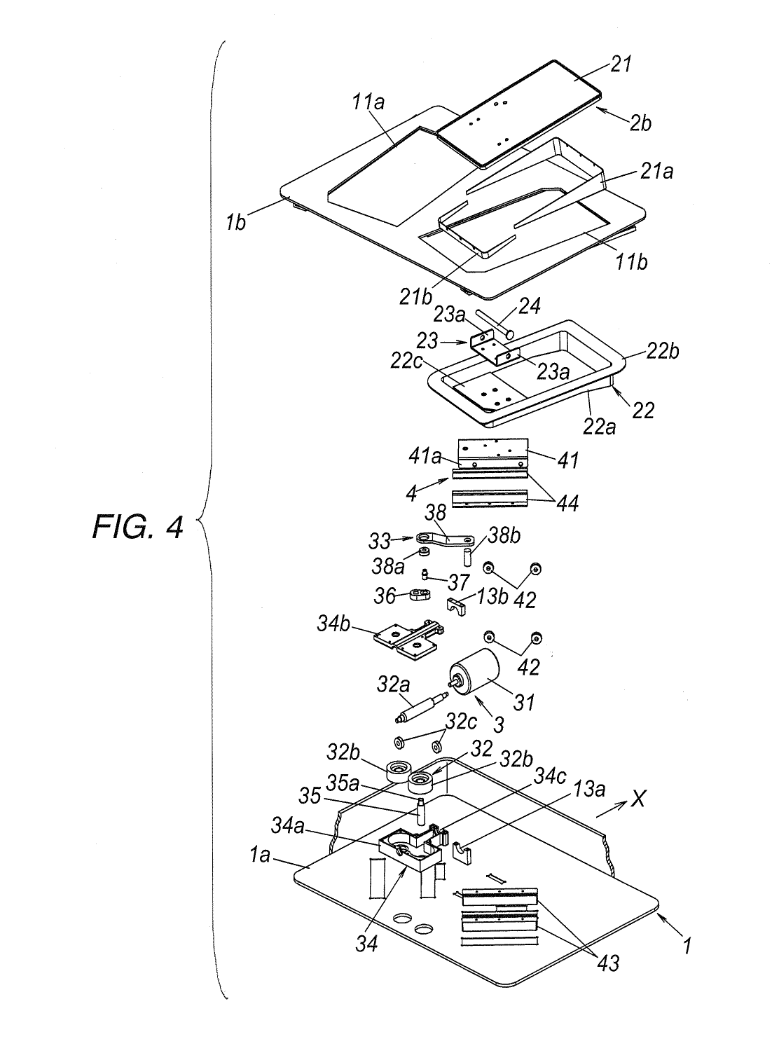

As shown in FIGS. 3 and 4, the housing 1 is formed into a rectangular shape which is laterally elongated in plane view, and composed of a base 1a having an opening at its top and a top plate 1b. The top plate 1b is attached to the periphery of the opening of the base 1a. The top plate 1b is provided with a pair of rectangular openings 11a, 11b to expose therethrough the left foot support 2a and the right foot support 2b. The rectangular openings 11a, 11b respectively have center axes extending along their longitudinal directions which are inclined from the lateral direction of the housing 1 and laterally spaced greater at their forward ends than at the rearward ends. The passive exercise apparatus in this embodiment comprises a driving unit 3 which is disposed within the housing 1 to be surrounded by the base 1a and the top plate 1b, for driving the left foot support 2a and the right foot support 2b.

Each of the left foot support 2a and the right foot support 2b comprises a foot plate 21 for supporting user's feet (the whole of user's sole), and a plate cover 22 which is disposed within the opening 11a, 11b to hold the foot plate 21. The foot plate 21 is made of a material having a large friction coefficient, and formed to have a sufficient dimension to prevent user from slipping therefrom. The plate cover 22 comprises a rectangular main body 22a, a flange 22b, and a fixing plate 22c integrally formed with the inner bottom of the main body 22a. The flange 22b is provided at the periphery of the opening of one surface (top surface) of the main body 22a. The main body 22a has dimensions in its longitudinal and lateral directions smaller than those of the openings 11a, 11b.

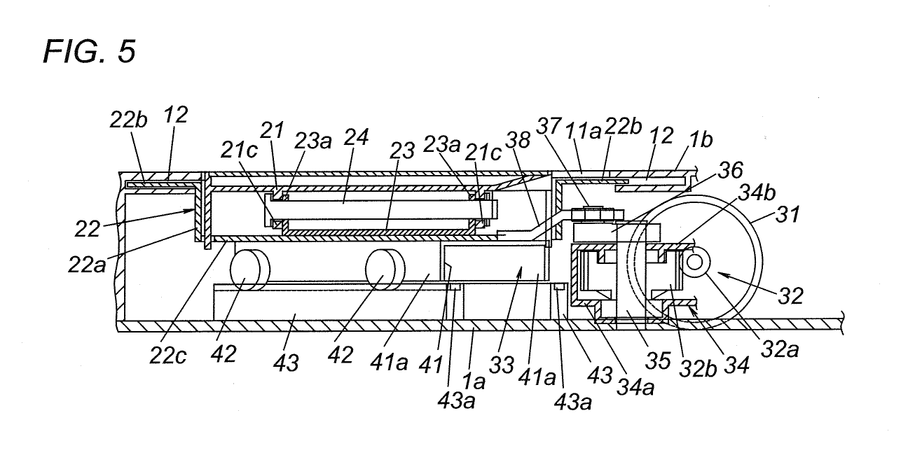

The top plate is provided with a pair of slide grooves 12, as shown in FIG. 5. The slide grooves have openings facing each other, and are positioned in the vicinity of opposite sides of each opening 11a, 11b, for slidaby receiving the flange 22b of the plate cover 22. The flange 22b of the plate cover 22 has dimensions in its longitudinal and lateral directions larger than those of each opening 11a, 11b. The slide groove 12 is formed to have a distance between its top and bottom faces larger than thickness at edge of the flange 22b. With this configuration, the plate cover 22 is allowed to be movable along the top plate 1b within the opening 11a, 11b while engaging with each slide groove 12.

The foot plate 21 is formed to have rectangular shape with a dimension slightly smaller than that of inner peripheral edge of the main body 22a of the plate cover 22. The foot plate 21 is formed at its bottom periphery integrally with substantially U-shaped cover fragments 21a, 21b which are combined to form a rectangular frame. The foot plate 21 is provided at a portion of its bottom face surrounded by the cover flagments 21a, 21b, with a pair of bearings 21c projecting therefrom. The bearings 21c are provided to face each other in the lateral direction of the foot plate 21.

Each of substantially U-shaped shaft supporting plates 23 is fixed to top face of the fixing plate 22c of the plate cover 22 so as to open upward. The foot plate 21 and the plate cover 22 are combined such that outer lateral faces of legs 23a of shaft supporting plate 23 are in intimate contact with the bearings 21c of the foot plate 21. The bearings 21c and legs 23a of the shaft supporting plate 23 are respectively provided with holes each of which allows a shaft 24 to pass therethrough. With this configuration, each foot plate 21 is allowed to swing around the shaft 24 extending along lateral direction of the foot plate 21, such that each of the front and rear ends of each foot plate 21 is allowed to move upward and downward alternately. The cover fragments 21a, 21b act to fill the gap between the foot plate 21 and the plate cover 22 during the swinging of the foot plate 21.

Each of substantially U-shaped carriages 41 is secured to the fixing plate 22c of the plate cover 22, so as to open downward. The carriage 41 is fixed at each of outer faces of its legs 41a to two wheels 42. Two rails 43 are provided for each of the left foot support 2a and the right foot support 2b, and fixed to top surface of the base 1a. Each carriage 41 is mounted on the rail 43 such that each wheel 42 is allowed to roll on the rail 43. Each rail 43 is formed at its top face with a rail groove 43a along its longitudinal direction for allowing the wheels 42 to roll thereon. Each rail 43 is also formed at its top face with a derailment prevention plate 44 for preventing the wheels 42 from derailing from the rail groove 43a. With this arrangement, the carriage 41, the wheel 42, the rail 43, and the plate 44 act together to form a guiding portion 4 to define paths for reciprocatory motions of the left foot support 2a and the right foot support 2b. Namely, each of the left foot support 2a and the right foot support 2b is allowed to be movable along the rail 43 in its longitudinal direction.

Each rail 43 is formed to have its longitudinal direction different from that of each opening 11a, 11b. Namely, each rail 43 and each opening 11a, Mare respectively disposed such that longitudinal directions of each rail 43 and each opening 11a, 11b are inclined from the lateral direction of the housing 1 at different inclination angles. For instance, each rail 43 is disposed to have a longitudinal direction inclined at 45 degrees, while each opening 11a, 11b is disposed to have a longitudinal direction inclined at 30 degrees from the lateral direction of the housing. The left foot support 2a and the right foot support 2b are configured to move along respective rails 43 each having longitudinal direction inclined from that of the each opening 11a, 11b. When user places his/her feet on the left foot support 2a and the right foot support 2b along their longitudinal direction such that his feet are spaced greater at his both toes, the left foot support 2a and the right foot support 2b are driven to move along the respective rails 43 such that longitudinal direction of his feet are crossed with each other.

The driving unit 3 comprises a motor 31 acting as a driving source for generating driving force, and a router 32 for transmitting the driving force of the motor 31 to each foot support 2a, 2b, and a reciprocator 33 for reciprocating each foot support 2a, 2b along the longitudinal direction of the rail 43 with the use of the driving force. The router 32 may be configured to transmit driving force from the reciprocator 33 to the foot supports 2a, 2b.

Specifically, the motor 31 is fixed to the base 1a so as to align output shaft 31a in forward/rearward. The output shaft 31a is connected to the router 32. The router 32 is composed of a worm 32a coupled to the output shaft 31a of the motor 31, and a pair of worm wheels 32b engaging with the worm 32a. This configuration enables to convert the rotary force of the output shaft 31a of the motor 31 into rotary forces of the two worm wheels 32b. A gear box 34 is composed of a gear case 34a opening at its top and a lid 34b attached to the periphery of the opening of the gear case 34a. The gear box 34 is fixed to the base 1a, and accommodates therein the worm 32a and two worm wheels 32b. The motor 31 is mounted onto a receiving portion 34c of the gear case 34a and a receiving plate 13a fixed to the base 1a. The motor 31 is fixed with a fixing plate 13b which is secured to the lid 34 and the receiving plate 13a. A pair of bearings 32c is disposed between the gear case 34a and the gear cover 34b to receive opposite longitudinal ends of the worm 32a.

Rotary shafts 35 are respectively inserted into the worm wheels 32b. The rotary shafts 35 are disposed to extend vertically, and held to the gear case 34a and the gear cover 34b. Each rotary shaft 35 is coupled to the worm wheel 32b, so as to rotate therewith. Each of the rotary shafts 35 is formed at its top with a coupling portion 35a having a non-circular section (rectangular section in Figure).

The reciprocator 33 comprises a crank plate 36 and a crank rod 38. The crank plate 36 has one end which is coupled to the coupling portion 35a of the rotary shaft 35 passing through the lid 34b. The crank rod 38 is coupled at the other end to the crank plate 36 via a crank shaft 37 The crank shaft 37 has one end fixed to the crank plate 36. The crank shaft 37 has the other end rotatably coupled to crank rod 38 while being held by a bearing 38a supported to one end of crank rod 38. In addition, the crank rod 38 is rotatably coupled at the other end to the carriage 41 through a shaft 38b.

The guiding portion 4 is configured to guide each of the carriages 41 to move along the longitudinal direction of the rail 43. With this configuration, the rotary force of the worm wheel 32b is converted into driving force for reciprocatory motion of each carriage 41 along the rail 43. The crank rods 38 are provided for both worm wheels 32b. The carriage 41 is provided for each of the left foot support 2a and the right foot support 2b. In this configuration, each of the left foot support 2a and the right foot support 2b is driven to reciprocate. Namely, the rotary force of the motor 31 is transmitted to the crank plate 36 through the worm 32a and the worm wheel 32b, and then transmitted to the carriage 41 through the crank rod 38 coupled to the crank plate 36, in order to give reciprocatory motion of each of the left foot support 2a and the right foot support 2b along the longitudinal direction of the rail 43.

In this embodiment, the rotary force of the motor 31 is converted into driving forces for motions of the left foot support 2a and right foot support 2b by means of the router 32 (the worm 32a and the worm wheel 32b), thereby enabling to drive the left and foot supports 2a and 2b to reciprocate in a mutually linked manner by the drive unit 3. In this embodiment, components for transmitting the rotary force of the worm 32a to the carriage 41 are disposed to be laterally symmetric such that the worm 32a engages at its opposite sides with both worm wheels 32b. With this embodiment, the left foot support 2a the right foot support 2b are driven to reciprocate in phase difference of 180 degrees. When the left foot support 2a is positioned at a front end of left path, the right foot support 2b is positioned at rear end of right path. When the left foot support 2a is positioned at a rear end of left path, the right foot support 2b is positioned at front end of right path. The phase difference in reciprocatory motions of the left foot support 2a and the right foot support 2b are suitably set by adjustment in positions of the worm wheels 32b engaging with worm 32a.

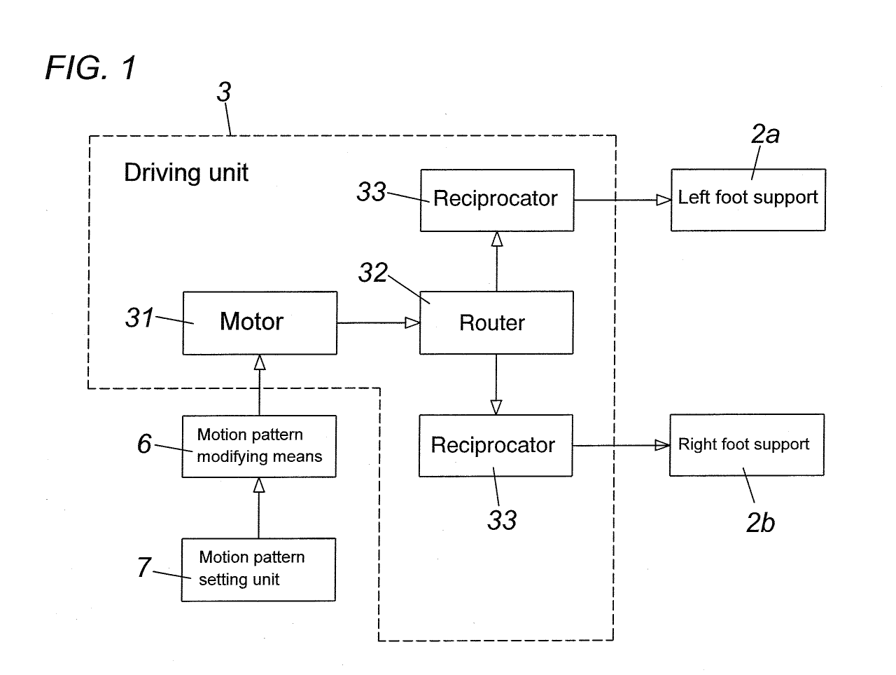

The passive exercise apparatus In this embodiment comprises a motion pattern modifying means 6, as shown in FIG. 1. The motion pattern modifying means 6 is configured to modify a pattern of reciprocatory motion (which is referred to as a motion pattern, hereafter) of each of the left foot support 2a the right foot support 2b. The motion pattern is defined by selected frequency, phase, and amplitude. The motion pattern modifying means 6 in this embodiment is configured to control motion speeds of the left foot support 2a the right foot support 2b in order to modify the frequency.

This motion pattern modifying means 6 is configured to modify the motion pattern in accordance with a motion pattern determined at a motion pattern setting unit 7. Specifically, the motion pattern modifying means 6 includes a control circuit for controlling a rotary speed of the motor 31, such that the left foot support 2a the right foot support 2b are driven to reciprocate at a frequency determined at the motion pattern setting unit 7. The rotary speed of the motor 31 can be regulated by using a means of regulating electric power supplied to the motor 31 such as PMV control means.

The motion pattern setting unit 7 acts to send a signal corresponding to any of factors (frequency in this embodiment) in determination of the motion pattern, to the motion pattern modifying means 6, in accordance with an input regarding a specific speed of the reciprocatory motion of each foot support 2a,2b which is selected among several speeds by user at a setting portion (not shown). In this configuration, it is possible to suitably select motion speeds of the left foot support 2a the right foot support 2b by user at the setting portion. The setting portion may be disposed at a portion of the housing 1, or may be a wireless remote controller which can be operated by user during his/her exercise. As another example, the motion pattern setting unit 7 may be provided with a timer which is embedded therein to measure a cumulative operation time of the passive exercise apparatus for user's exercise (i.e., a cumulative time in user's exercise with the aid of the passive exercise apparatus), so as to give a signal for modification of the motion pattern to the motion pattern modifying means 6 when the cumulative time amounts to a predetermined time. Instead, the motion pattern modifying means 6 may be configured to give a suitable signal for determination of the motion pattern, in response to outputs of the load sensors S1,S2 varying with user's motion.

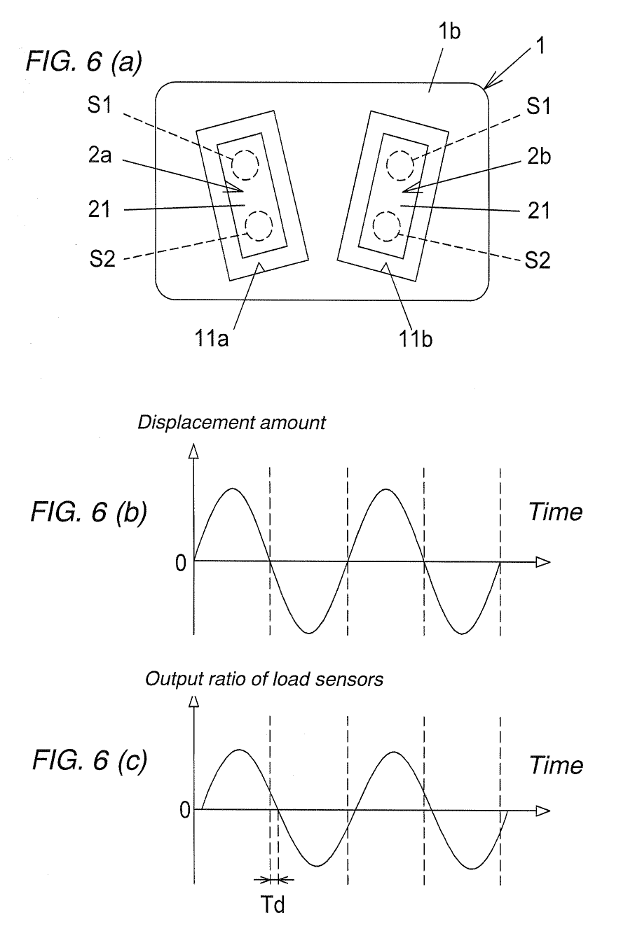

The left foot support 2a the right foot support 2b are driven to reciprocate while supporting thereon user's left and right feet, varying a displacement amount of each foot plate 21. The displacement amount of each foot plate 21 is determined with reference to the middle position (which is referred to as an initial position, hereafter) of motion range of each foot support 21. While each foot support 21 moves forward and backward, the displacement amount of each foot plate 21 varies positively and negatively, respectively. The displacement amount fluctuates with the reciprocatory motion of each of the left foot support 2a and the right foot support 2b at the same frequency, as shown in FIG. 6(b). When properly giving the reciprocatory motion to user, the passive exercise apparatus gives the maximum load on front end of the foot plate 21 positioned in the front end of its motion range, or the maximum load on rear end of the foot plate 21 positioned in the rear end of its motion range. In connection with this motion, output ratio of the load sensors S1, S2 fluctuates with the variations in the displacement amount of the foot plate 21 at the same frequency, as shown in FIG. 6(c). In this configuration, the motion pattern setting unit 7 is configured to measure the output ratio of the load sensors S1, S2, for obtaining a phase difference Td between variation in the output ratio of the load sensors and that in the displacement amount. The motion pattern setting unit 7 is arranged to determine that the user properly exercises in response to a phase difference Td equal to or less than a predetermined threshold. Alternatively, the motion pattern setting unit 7 determines that the user improperly exercises in response to a phase difference Td above the predetermined threshold.

When determining that the user has properly exercised continuously for a predetermined time or longer, the motion pattern setting unit 7 instructs the motion pattern modifying means 6 to modify the motion pattern. Namely, the motion pattern is kept unchanged unless the user has properly exercised continuously for a predetermined time. Alternatively, this passive exercise apparatus may be configured to determine that user's feet are improperly positioned on the foot plates when receiving no response from the load sensors S1, S2, and then modifying the motion pattern for giving an attention to user. This passive exercise apparatus may be provided with a switch which operates in response to overloads applied thereon, instead of load sensors S1, S2, for the purpose of operating in the same way.

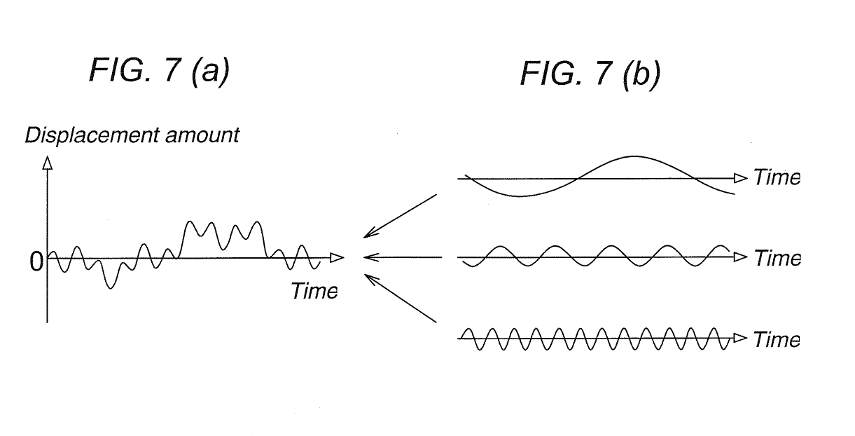

In this embodiment, the motion pattern modifying means 6 may be configured to define the motion pattern which is obtained by superposition of a plurality of sinusoidal waveforms of different frequencies, as shown in FIG. 7. Three sinusoidal waves of different frequencies in FIG. 7(b) are superimposed to give a superimposed waveform in FIG. 7(a). With this arrangement, it is possible to give complicated motions defined by plural sinusoidal waves of different frequencies as well as simple reciprocatory motion defined by a single sinusoidal waveform. This passive exercise apparatus enables user to experience an improved effect of exercise by giving variations in the motion pattern, even though the motion pattern of each foot support 2a,2b is hardly realized by the user. The passive exercise apparatus may be configured to give motion patterns defined by relatively high frequencies, for the purpose of stimulating muscles over user's entire body including those of his/her feet.

Each foot plate 21 is rotatably supported to each plate cover 22 for swinging around the shaft 24, such that the front and rear ends of each foot plate 21 move upward and downward alternately. With this arrangement, the passive exercise apparatus enables to move user's toe and heel upward and downward alternately, hence making dorsi flexion and plantar flexion. The foot plates 21 may be configured to swing in connection with the reciprocatory motions of the left foot support 2a the right foot support 2b which are driven by the driving unit 3. Instead, the foot plate 21 may be driven to move while being inclined at a constant angle from a horizontal plane irrespective of the reciprocatory motions of the left foot support 2a the right foot support 2b. The foot plate 21 swings such that each ankle is allowed to make dorsi flexion and plantar flexion for stretching and contracting user's calf as well as prompting blood circulation from veins in user's feet, thereby improving blood circulation of the user. This passive exercise apparatus helps user to rotate his/her ankles so as to induce reactions of nerve system for maintaining his/her balance, thereby stimulating muscles of his/her feet and back.

In this embodiment, the foot plate 21 is configured to swing around a center shaft (a shaft portion 24) extending along the lateral direction of the foot plate 21, but may be configured to swing around a shaft extending along longitudinal or vertical direction of the foot plate 21, or swing with use of these plural shafts. Each foot support 21 swings around its longitudinal direction, enabling users having X-shaped or O-shaped feet to exercise for normalizing one of his/her feet by adjustment of each foot support 2a, 2b. This passive exercise apparatus enables user to stimulate muscles in inner and outer portions of his/her feet by the adjustment in the inclination angles, thereby prompting activation of his/her muscles. This passive exercise apparatus also enables user to wrench his/her body by giving reciprocatory motions to the left foot support 2a and the right foot support 2b alternately. Furthermore, this passive exercise apparatus can be configured such that the foot plate 21 swings around its longitudinal direction so as to further wrench his/her body to a greater extent.

Prior to operation of the above passive exercise apparatus, user needs to stand on this apparatus with his/her both feet being supported on the left and right foot supports 2a and 2b which are stopped in their initial positions. In this condition, the left foot support 2a and the right foot support 2b are respectively positioned such that longitudinal directions of the foot supports cross with each other at a portion in forward/back direction (for example, a direction indicated by X). With this configuration, it is possible for user to stand in his/her normal stance with his feet being placed on the foot supports 2a, 2b such that his feet are spaced greater at his/her toes than at his/her heels.

Each of the left foot support 2a and the right foot support 2b is initially located at the middle of its motion range. When the user stands on the left foot support 2a and the right foot support 2b stopped in their initial positions, user's gravity point is substantially positioned on a vertical line passing the middle between the left foot support 2a and the right foot support 2b. During operation of the driving unit 3, the left foot support 2a and the right foot support 2b are driven to move forward and backward while changing their positions in lateral direction. The foot supports 2a, 2b are driven to reciprocate along the respective linearly extending rails 43.

In this embodiment described above, each of the left foot support 2a and the right foot support 2b is configured to reciprocate along the linear path parallel to longitudinal direction of each rail 43 The passive exercise apparatus in this invention is not limited to the specific paths for the reciprocatory motions of the foot supports. Other paths can be suitably employed such as a curved path and a meandering path. Alternatively, each of the left foot support 2a and the right foot support 2b may be configured to reciprocate along different paths provided for its forward motion and its backward motion. In the above embodiment, the left foot support 2a and the right foot support 2b are configured to move along substantially V-shaped paths which are laterally spaced greater at their front ends than at their rear ends. Instead, the left foot support 2a and the right foot support 2b may be configured to move along substantially V-shaped paths which are laterally spaced greater at their rear ends than at their front ends. Instead, the paths may be configured to extend forward/rearward direction to be laterally spaced evenly at their front ends and at rear ends. Alternatively, the paths may be configured to extend laterally while keeping constant their positions in forward/rearward direction, or configured to extend vertically.

The present invention is not limited to the above components of the driving unit 3, but may be formed of other components for driving the left foot support 2a and the right foot support 2b to reciprocate by driving forces generated by the motor 31 and other driving sources. For instance, the rotary force of the output shaft 31a of the motor 31 may be converted into those for rotary motions of the crank plate 36 each having a rotating shaft perpendicular to the output shaft 31a by means of a pair of bevel gear instead of the worm 32a and the worm wheel 32b. Alternatively, the motor 31 may be disposed such that the output shaft 31a extends along its vertical direction, for the purpose of transmitting the rotary force of the motor 31 to the crank plate 36 by means of plural spur wheels or a combination of belt and pulley. The plank plate 36 and the crank rod 38 may be replaced respectively with an eccentric cam and a cam follower designed to follow the eccentric cam, in order to reciprocate the left foot support 2a and the right foot support 2b with the aid of the rotary force.

### Second Embodiment

The passive exercise apparatus in this embodiment is different from that in first embodiment, with respect to the motion pattern modifying means 6 which is configured to modify a phase determining the motion pattern of reciprocatory motion of each of the left foot support 2a and the right foot support 2b.

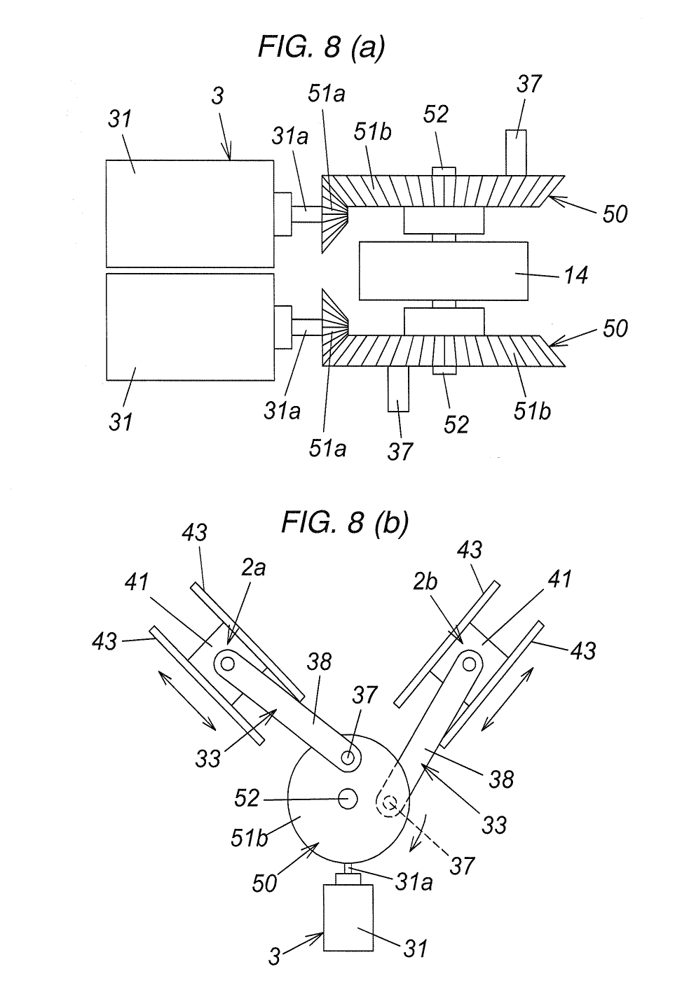

In this embodiment, the driving unit 3 is provided with two motors 31 as shown in FIG. 8(a) for individually driving the left foot support 2a and the right foot support 2b. This configuration comprises a transmitter 50 for transmitting the rotary force of the motor 31 to the crank rod 38, instead of the router 32 (the worm 32a and the worm wheel 32b) for converting the rotary force of the motor 31 into two individual driving forces.

The transmitter 50 includes a first bevel gear 51a and a second bevel gear 51b engaging with the first bevel gear 51a, for converting the rotary force of the motor 31 into that of the second bevel gear 51b. The pair of motors 31 and the pair of the second bevel gear 51b are disposed to align in vertical direction. A rotary shaft 52 is held to a shaft support 14, and inserted into the second bevel gears 51b at its center to vertically extend. The shaft support 14 is fixed to the base 1a. The rotary shafts 52 are inserted into respective second bevel gears 51b, and are disposed along a common vertical line. The rotary shafts 52 are configured to rotate individually.

The crank rod 38 of the reciprocator 33 is connected to the second bevel gear 51b via crank shaft 37, as shown in FIG. 8(b). The crank shaft 37 is fixed at its one end to the second bevel gear 51b, and supported at the other end to a bearing 38b which is held at one end of the crank rod 38, so as to be rotatably coupled to the crank rod 38. The crank rod 38 is rotatably coupled at its other end to the carriage 41. In this embodiment, the crank shaft 37 is fixed to the second bevel gear 51b to be spaced from the rotary shaft 52, for rotating around the rotary shaft 52 in response to the rotation of the rotary shaft 52. The upper second bevel gear 51b (the second bevel gear 51b for driving the left foot support 2a in this embodiment) is connected at its top to the crank rod 38. The lower second bevel gear 51b (the second bevel gear 51b for driving the right foot support 2b in this embodiment) is connected at its bottom to the crank rod 38. With this configuration, it is possible to prevent an interference between the crank rods.

With this configuration, the rotary force of the second bevel gear 51b is converted into driving forces for reciprocatory motions of the left foot support 2a and the right foot support 2b by means of the crank rods 38. Namely, the rotary force of the motor 31 is transmitted to the crank rods 38 via the first bevel gear 51a and the second bevel gear 51b. In addition, the driving force for crank rod 38 is transmitted to the carriage 41, for reciprocating each of the left foot support 2a and the right foot support 2b along the rail 43 in its longitudinal direction.

As mentioned above, the motors 31 are provided individually for the left foot support 2a and the right foot support 2b, so as to control the motions of the left foot support 2a and the right foot support 2b individually by the driving unit 3.

In this embodiment, the motion pattern modifying means 6 includes a control circuit for controlling the motors 31 individually, and is configured to modify the phase determining reciprocatory motions of the left foot support 2a and the right foot support 2b. Each of the motors 31 is driven to rotate at a rotary speed, so as to reciprocate the left foot support 2a and the right foot support 2b at a phase difference (e.g., 0 to 360 degrees) determined by the motion pattern setting unit 7.

The exercise pattern modifying means 6 in this embodiment allows the motor 31 to be controlled during one reciprocatory motion of the left foot support 2a such that the right foot support 2b is driven to move at half speed with respect to the motion of the left foot support 2a, in order that the phase difference in reciprocatory motion between the left foot support 2a and the right foot support 2b is modified into 180 degrees from 0 degree. The exercise pattern modifying means 6 in this embodiment also allows the motor 31 to be controlled during one reciprocatory motion of the left foot support 2a such that the right foot support 2b is driven to move at one quarter speed with respect to the motion of the left foot support 2a, in order that the phase difference in reciprocatory motion between the left foot support 2a and the right foot support 2b is modified into 90 degrees from 0 degree. After achieving the desired phase difference, the exercise pattern modifying means 6 equalizes frequencies (speeds) in reciprocatory motions of the left foot support 2a and the right foot support 2b.

Namely, the passive exercise apparatus in this embodiment is configured to modify the phase difference in reciprocatory motion between the left foot support 2a and the right foot support 2b by means of the exercise pattern modifying means 6. When the phase difference is set at 180 degrees, this passive exercise apparatus enables to minimize fluctuation in the user's gravity point in forward/rearward direction, for being made suitable to users having a generated balance function. When the phase difference is set at a degree (e.g., 90 degrees) less than 180 degrees, this passive exercise apparatus enables to enlarge the fluctuation in the user's gravity point in forward/rearward direction, prompting responses of nervous system for maintaining his/her balance, and eventually activating muscles of his/her back as well as those of his/her feet.

In this embodiment, upper and lower second bevel gears 51b are driven to rotate by the respective motors 31. Both second bevel gears 51b may be driven to rotate by a single motor 31 instead of the respective motors 31. In this configuration, the shaft support 14 is provided at its interior with an adjustable means such as a ratchet for allowing two rotary shafts 52 to be coupled or separated. The rotary shafts 52 are coupled to allow both second bevel gears 51b to rotate with the aid of the single motor 31 in normal condition. One of second bevel gears 51b can be driven to rotate while two second bevel gears 51b being separated, in order to modify the phase difference in reciprocatory motion between the left foot support 2a and the right foot support 2b in this configuration.

Other components and functions in this embodiment are nearly identical to those in the first embodiment.

### Third Embodiment

The passive exercise apparatus in this embodiment is different from that in first embodiment, with respect to the motion pattern modifying means 6 which is configured to modify amplitude defining the motion pattern of reciprocatory motion of each of the left foot support 2a and the right foot support 2b.

The driving unit 3 in this embodiment is composed of the same fundamental components as those in the second embodiment in which two motors 31 are provided. The driving unit 3 in this embodiment is different from that in the second embodiment, with respect to a mechanism for modifying portions of the crank shafts 37 connecting to the second bevel gears 51b.

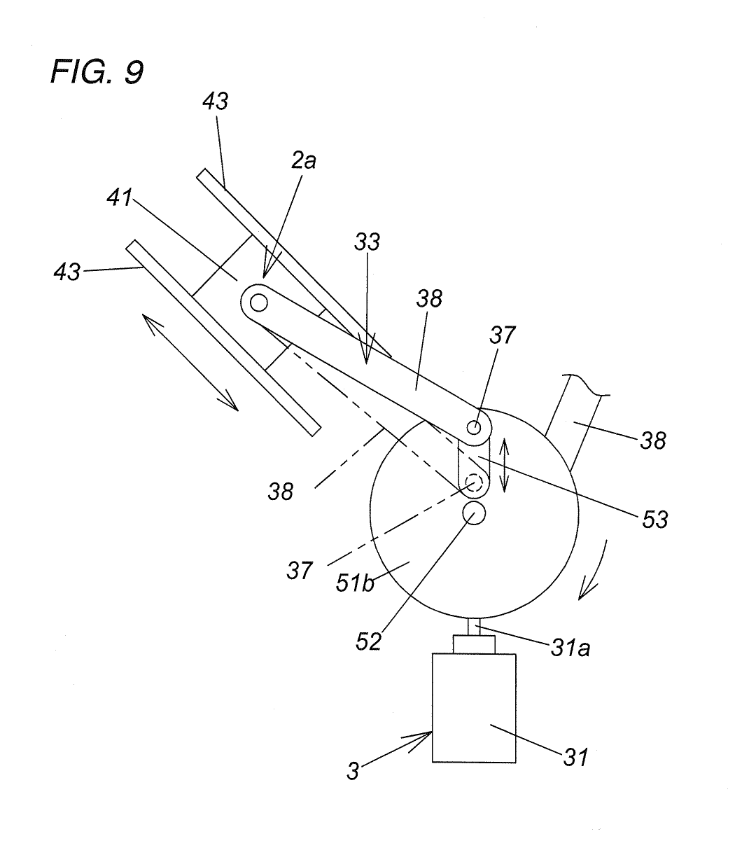

In this embodiment, the second bevel gear 51b is formed with a groove 53 to receive the crank shaft 37, as shown in FIG. 9. The crank shaft 37 is configured to be movable within the groove 53. The groove 53 extends along a radius of the second bevel gear 51b at its one surface, enabling to make changeable the distance between the crank shaft 37 and the rotary shaft 52 of the second bevel gear 51b. The crank shaft 37 is designed to rotate around the shaft 52 while being spaced from the shaft 52 at a constant interval corresponding to the distance between the rotary shaft 52 and the crank shaft 37. In this configuration, the amplitude (stroke) of reciprocatory motion of each carriage 41 increases with the distance between the rotary shaft 52 and the crank shaft 37. The same components are provided for the right foot support 2b as for the left foot support 2a shown in FIG. 9.

The exercise pattern modifying means 6 is provided with a control circuit for changing the position of the crank shaft 37 within the groove 53. The motion pattern modifying means 6 drives the crank shaft 37 to move away from the rotary shaft 52 for increasing the amplitude of reciprocatory motion of each of the left foot support 2a and the right foot support 2b. Alternatively, the motion pattern modifying means 6 drives the crank shaft 37 to move towards the rotary shaft 52 for decreasing the amplitude of reciprocatory motion of each of the left foot support 2a and the right foot support 2b.

A worm gear is provided to one side of the groove 53. The crank shaft 37 is provided with a gear segment for engaging with the worm gear. With this arrangement, the crank shaft 37 is driven to move within the groove 53, in response to the rotation of the worm gear. The worm gear may be driven to rotate by a compact motor mounted to the second bevel gear 51b, but may be configured to be driven by rotary force of the above motor 31.

The second bevel gear 51b may be formed with a plurality of screw holes instead of the groove 53. In addition, the crank shaft 37 may be provided with screws engaging with the screw holes. With this arrangement, this passive exercise enables to modify the amplitude of reciprocatory motion of each carriage 41 by altering the distance between the crank shaft 37 and the rotary shaft 52.

The passive exercise apparatus in this embodiment enables to modify the amplitude (stroke) of reciprocatory motions of the left foot support 2a and the right foot support 2b by means of the exercise pattern modifying means 6. This passive exercise apparatus enables to apply loads mainly on muscles of user's feet to improve his/her exercise effects by increasing the amplitude.

The exercise pattern modifying means 6 is configured to modify at least one of frequency, phase, and amplitude which determine a motion pattern of the reciprocatory motion of each of the left foot support 2a and the right foot support 2b. Instead, the exercise pattern modifying means 6 may be configured to modify any of frequency, phase, and amplitude or a combination thereof in response to the output ratio of load sensors S1, S2.

Other components and functions in this embodiment are nearly identical to those in the first or second embodiment.

1. A passive exercise apparatus comprising:
a left foot support and a right foot support provided to support user's left foot and right foot respectively;
a driving unit for giving a reciprocatory motion along a predetermined path to each of said left foot support and said right foot support according to a predetermined motion pattern defined by frequency, phase, and amplitude of the reciprocatory motion; and
a motion pattern modifying means configured to modify at least one of the frequency, the phase, and the amplitude with time.

2. The passive exercise apparatus as set forth in claim 1, wherein
said motion pattern modifying means is configured to define the motion pattern which is obtained by superposition of a plurality of sinusoidal waveforms of different frequencies.
